(19) United States
(12) Patent Application Publication
(10) Pub. No.: US 2005/0037162 A1
(43) Pub. Date: Feb. 17, 2005

(54) Paperboard laminate for food packaging applications

(76) Inventor: John Peter Adams, Wilder, KY (US)

Correspondence Address: INTERNATIONAL PAPER COMPANY, 6285 TRI-RIDGE BOULEVARD, LOVELAND, OH, 45140, US

(21) Appl. No.: 10/638,511

(22) Filed: Aug. 11, 2003

(51) Int. Cl. B32B 15/08; B32B 27/08; B32B 27/10; B32B 27/36; B32B 27/34; B32B 27/32

(52) U.S. Cl. 428/34.2; 428/461; 428/476.9; 428/483; 428/513; 428/516; 428/523

(57) ABSTRACT

A laminate structure having improved resistance to the migration of essential oils, aromas and flavors and improved oxygen barrier characteristics for beverage packaging comprising an exterior coating of polyethylene applied onto the outer surface of paperboard substrate, a barrier layer of aluminum foil, EVOH, polyamide or PET applied directly or indirectly onto the paperboard and tie and other sublayers which may or may not contain inorganic filler applied intermediate the barrier layer and the innermost food contact layer which may or may not contain filler. The containers or cartons prepared from the laminate structures are characterized by minimized scalping and preserved product quality.

This invention relates to paperboard laminates for food packaging applications and more particularly paperboard laminates for food packaging which are effective to reduce flavor component scalping by polymeric materials provided in the laminate between the food product and the functional oxygen barrier layer. More particularly, the invention relates to a laminate structure wherein the innermost food contact sealant layer is filled with an inorganic particulate filler that serves to reduce the flux rate and quantity of flavor and aroma components migrating from the food product into the polymer layers disposed on the food contact side of the primary functional barrier layer of the laminate.

### BACKGROUND OF THE INVENTION

Scalping is the conventional term used for describing the net loss of a product attribute into the packaging resulting in a perceivable loss in product quality. Scalping is almost always considered a negative attribute, so attempts to minimize scalping by some means are desirable.

Packaging for foodstuffs containing flavor components utilize one type of functional barrier, namely an oxygen barrier in order to drastically reduce oxygen permeation through the packaging material into the product. Oxygen can react with sensitive flavor compounds to produce diminished intensity, alter the flavor profile or generate undesirable aroma or tastes. Typically the functional barrier materials are not sealable, requiring that sealants materials be employed resulting in significant scalping.

The invention herein provides a practical packaging material that has good oxygen barrier properties, is effective to minimize scalping over a broad range of food systems, and provides a sealable food contact layer to achieve containment.

### SUMMARY OF THE INVENTION

According to the present invention, there is provided in a laminate structure a food contact sealant layer, a functional barrier layer and sublayer(s) disposed between the food product and the functional barrier layer in which the food contact sealant layer and/or sublayer(s) has an inorganic particulate filler incorporated therein.

### BRIEF DESCRIPTION OF THE ACCOMPANYING DRAWINGS

The present invention is described and explained in greater detail hereinbelow, with the aid of non-restrictive embodiments and with particular reference to the accompanying drawings, in which

FIG. 1 schematically illustrates a cross section of a packaging laminate according to present invention;

FIG. 2 schematically illustrates a cross section of second packaging laminate according to present invention;

FIG. 3 schematically illustrates a cross section of third packaging laminate according to present invention; and

FIG. 4 schematically illustrates a cross section of fourth packaging laminated according to present invention.

### DETAILED DESCRIPTION OF THE INVENTION

The laminate structure of the invention can be used in laminates comprising a coated paperboard substrate for use in the production of containers and cartons for products such as juices, punches, milk and other beverages. Such multilayer laminate structures comprise a paperboard substrate, one or more functional barrier layers of aluminum foil, nylon, EVOH, or PET overlying the interior surface of the substrate, and one or more polyolefin layers overlaying the functional barrier layer, at least one of which has incorporated therein an inorganic particulate filler added. A tie layer may be provided and this tie layer may be provided with or without inorganic particulate filler. A layer of polyolefin is preferably coated on the exterior surface of the paperboard substrate.

The particulate filler useful for blending into food contact, sublayer(s) and tie layer can be an inorganic or organic material and is preferably a rigid material.

Specific examples of inorganic particulate fillers include, metal carbonates, such as barium carbonate, calcium carbonate, and magnesium carbonate, metal hydroxides, such as aluminum hydroxide, and magnesium hydroxide, metal oxides, such as calcium oxide, magnesium oxide, titanium oxide, titanium dioxide and zinc oxide, metal sulfates, such as barium sulfate, calcium sulfate, and magnesium sulfate, clay, kaolin, talc, silica, diatomaceous earth, alumina, mica, glass powder, and zeolites.

Although the invention will be hereinafter described with reference to inorganic particulate filler materials, organic particulate materials can also be used as fillers, as for example, finely divided cellulosic fibers, and in particular such fibers obtained from wood pulps as used in the paper industry.

Commercial examples of suitable particulate filler concentrates include Heritage HM-10 (Heritage Plastics) and Omyacarb 2SST (OMYA, Inc.). These filler concentrates contain the filler, in this case calcium carbonate, at loadings of about 30 to about 80%, preferably about 50 to about 75% by weight of the carrier resin.

The average size of the particulate filler should be about 0.1 micron to about 10 microns, preferably, about 0.5 microns to about 5 microns, and more preferably about 0.7 microns to about 3 microns.

Representative of preferred fillers are calcium carbonate, clay, TiO₂, and silica. Calcium carbonate is a particularly preferred filler because it is relatively inexpensive and readily available.

The calcium carbonate or equivalent filler is generally available as a masterbatch in LDPE, LLDPE, or other polyolefin. Heritage HM-10 concentrate which is 75% calcium carbonate and 25% LLDPE is an instance of a particularly preferred filler.

As functional barrier layer, there may be used polyamide, ethylene vinyl alcohol copolymers, polyethylene terephthalate or aluminum foil.

Acceptable polyamides can be, but are not limited to, nylon 6, nylon 66, nylon 10, nylon 6-10, nylon 12, amorphous nylons, MXD-6, nylon nanocomposites, nylon combined with inorganic fillers (such as talc or kaolin), and blends of nylon with other polymers (such that the nylon remains the continuous phase).

Suitable EVOH materials can be, but are not limited to, ethylene vinyl alcohol copolymers containing 26-44 mole % ethylene, oxygen scavenging EVOH materials, EVOH nanocomposites, EVOH combined with other inorganic fillers (such as talc or kaolin), and blends of EVOH with other polymers (such that the EVOH remains the continuous phase). Polyvinyl alcohols (PVOH) can also be used.

Acceptable polyethylene terephthalates include, but are not limited to, glycol-modified polyethylene terephthalates, acid-modified polyethylene terephthalates, PET nanocomposites, PET combined with other inorganic fillers (such as talc or kaolin), and blends of PET with other polymers (such that the PET remains the continuous phase).

Suitable polyolefins for use as sublayers include, but are not limited to, LDPE, HDPE, LLDPE, polypropylene, cyclic olefin copolymers (COC), and blends thereof. Preferred polyolefins, respectively, are Voridian 1924P/Chevron 4517, Voridian M2004P, Dowlex 3010, Chevron Marlex 360, and Ticona Topas 8007.

Acceptable as adhesive tie layers are polyolefin, anhydride modified polyolefin, ethylene acrylic acid, ethylene methyl acrylic acid, ethylene vinyl acetate, ionomer or other suitable adhesive polymer necessary to provide adhesion between food contact, sublayer(s) and functional barrier. Preferred sublayer or tie layer resins, respectively, are polyolefins above, Equistar Plexar PX 5125, Dow Primacor® 3340, Dupont Nucrel® 0910HS, Dupont Bynel® 1123, Dupont Surlyn® 1652.

Economic and converting configuration considerations dictate whether one, some or all layers between the functional barrier and food product have filler added.

The filler masterbatch is dry blended with the polymer to be filled at the time of processing, such that the final loading levels are 1-75 wt % filler and typically 10-75 wt % filler.

The basis weight of the paperboard utilized in preparing the laminate structures for their intended use as cartons and containers can vary from 80 to 300 lbs./3000 sq. ft. with a preference of 140-280 lbs./3000 sq. ft.

Applying the tie layer and other layers can be achieved by either coextrusion or by standard lamination or extrusion lamination processes.

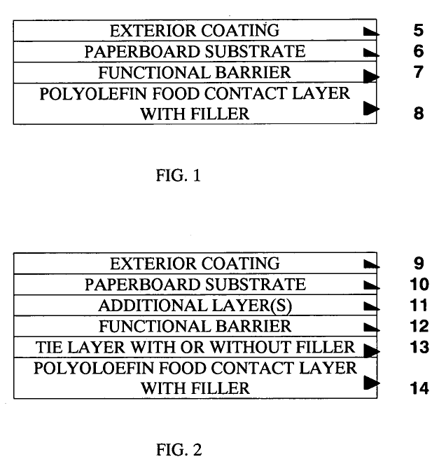

In FIG. 1, layer 5 is the exterior coating that is typically printed and in this embodiment applied directly onto the paperboard substrate 6. A functional barrier layer 7 is coated directly onto the paperboard substrate and an interior coating or food contact layer containing filler 8 is applied to the functional barrier layer.

The laminate structure of FIG. 2 comprises an exterior coating 9 that is applied onto the paperboard substrate 10. An additional layer or layers 11 is applied intermediate the paperboard substrate and the functional barrier layer 12. A tie layer 13 with or without filler is applied adjacent the barrier layer 12 and an interior layer or food contact layer containing filler 14 is applied onto the tie layer.

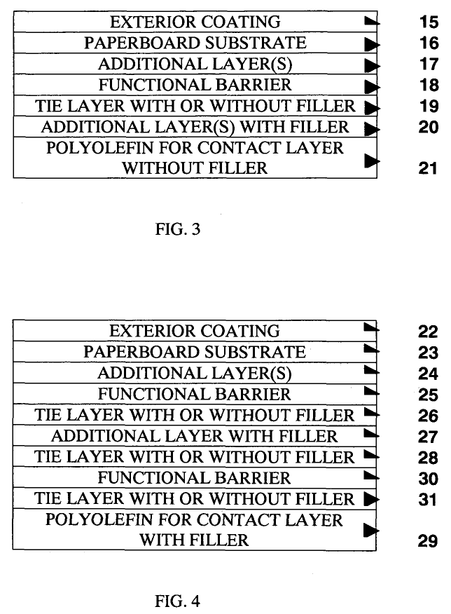

The laminate structure of FIG. 3 differs from the structure of FIG. 2 in that there is applied directly onto the tie layer with or without filler 19, an additional layer or layers containing filler 20 onto which layer(s) 20 an interior layer or food contact layer without filler 21 is applied.

The embodiment illustrated by the laminate shown in FIG. 4 basically differs from the laminate structure of FIG. 3 by having a tie layer with or without filler 28 interposed between the additional layer which contains filler 27 and the interior food contact layer 29 which in this embodiment contains filler and more specifically is separated therefrom by a second barrier layer 30 and a third tie layer 31 with or without filler. The invention also contemplates a structure such as shown in FIG. 4 in which the first functional barrier layer 25 has superposed thereon another, but different functional barrier layer, the last of the two barrier layers having applied thereon tie layer 26.

The following structures are among those contemplated as within the scope of the invention but are not to be construed in limitation thereof.

The following structures are provided for illustrating the invention and are not to be construed as limitations thereof.

| | Basis (pounds/ream) | Polymer | Polymer Type |
|---|---|---|---|
| A. | 8-20 | Polyolefin | LDPE, HDPE, LLDPE, PP, COC, or |
| | | | blends |
| | 80-300 | Paperboard | |
| | 1-15 | Functional Barrier | Polyamide, EVOH, PET, or blends |
| | 10-40 | Polyolefin Blend | LDPE, HDPE, LLDPE, PP, COC, or |
| | | 90-25% LDPE | blends |
| | | 10-75% CaCO3 | |
| B. | 8-20 | Polyolefin | LDPE, HDPE, LLDPE, PP, COC, or |
| | | | blends |
| | 80-300 | Paperboard | |
| | 1-15 | Functional Barrier | Polyamide, EVOH, PET, or blends with |
| | | | added filler |
| | 10-40 | Polyolefin Blend | LDPE, HDPE, LLDPE, PP, COC, or |
| | | 90-25% LDPE | blends |
| | | 10-75% CaCO3 | |
| C. | 8-20 | Polyolefin | LDPE, HDPE, LLDPE, PP, COC, or |
| | | | blends |
| | 80-300 | Paperboard | |
| | 3-20 | Polyolefin | LDPE, HDPE, LLDPE, PP, COC, or |
| | | | blends |
| | 10-30 | Aluminum Foil | 0.00025-0.0007″ |
| | 10-40 | Polyolefin Blend | LDPE, HDPE, LLDPE, PP, COC, or |
| | | 90-25% LDPE | blends |
| | | 10-75% CaCO3 | |
| D. | 8-20 | Polyolefin | LDPE, HDPE, LLDPE, PP, COC, or |
| | | | blends |
| | 80-300 | Paperboard | |
| | 3-20 | Tie Layer | EAA, EMAA, EVA, Ionomer, Anhydride- |
| | | | modified polyolefin |
| | 10-30 | Aluminum Foil | 0.00025-0.0007″ |
| | 10-40 | Polyolefin Blend | LDPE, HDPE, LLDPE, PP, COC, or |
| | | 90-25% LDPE | blends |
| | | 10-75% CaCO3 | |
| E. | 8-20 | Polyolefin | LDPE, HDPE, LLDPE, PP, COC, or |
| | | | blends |
| | 80-300 | Paperboard | |
| | 3-15 | Functional Barrier | Polyamide, EVOH, PET, or blends |
| | 3-20 | Tie Layer Blend | EAA, EMAA, EVA, Ionomer, Anhydride- |
| | | 90-25% Tie | modified polyolefin |
| | | Polymer | |
| | | 10-75% CaCO3 | |
| | 10-40 | Polyolefin Blend | LDPE, HDPE, LLDPE, PP, COC, or |
| | | 90-25% LDPE | blends |
| | | 10-75% CaCO3 | |
| | 1-10 | Polyolefin | LDPE, HDPE, LLDPE, PP, COC, or |
| | | | blends |
| F. | 8-20 | Polyolefin | LDPE, HDPE, LLDPE, PP, COC, or |
| | | | blends |
| | 80-300 | Paperboard | |
| | 3-20 | Polyolefin | LDPE, HDPE, LLDPE, PP, COC, or |
| | | | blends |
| | 10-30 | Aluminum Foil | 0.00025-0.0007″ |
| | 3-20 | Tie Layer | EAA, EMAA, EVA, Ionomer, Anhydride- |
| | | | modified polyolefin |
| | 10-40 | Polyolefin Blend | LDPE, HDPE, LLDPE, PP, COC, or |
| | | 90-25% LDPE | blends |
| | | 10-75% CaCO3 | |
| | 1-10 | Polyolefin | LDPE, HDPE, LLDPE, PP, COC, or |
| | | | blends |
| G. | 8-20 | Polyolefin | LDPE, HDPE, LLDPE, PP, COC, or |
| | | | blends |
| | 80-300 | Paperboard | |
| | 3-20 | Tie Layer | EAA, EMAA, EVA, Ionomer, Anhydride- |
| | | | modified polyolefin |
| | 10-30 | Aluminum Foil | 0.00025-0.0007″ |
| | 10-40 | Polyolefin Blend | LDPE, HDPE, LLDPE, PP, COC, or |
| | | 90-25% LDPE | blends |
| | | 10-75% CaCO3 | |
| | 1-10 | Polyolefin | LDPE, HDPE, LLDPE, PP, COC, or |
| | | | blends |
| H. | 8-20 | Polyolefin | LDPE, HDPE, LLDPE, PP, COC, or |
| | | | blends |
| | 80-300 | Paperboard | |
| | 1-15 | Functional Barrier | Polyamide, EVOH, PET, or blends |
| | 1-10 | Tie Layer | EAA, EMAA, EVA, Ionomer, Anhydride- |
| | | | modified polyolefin |
| | 5-30 | Polyolefin Blend | LDPE, HDPE, LLDPE, PP, COC, or |
| | | 90-25% LDPE | blends |
| | | 10-75% CaCO3 | |
| | 1-10 | Tie Layer | EAA, EMAA, EVA, Ionomer, Anhydride- |
| | | | modified polyolefin |
| | 1-15 | Functional Barrier | Polyamide, EVOH, PET, or blends |
| | 1-10 | Tie Layer | EAA, EMAA, EVA, Ionomer, Anhydride- |
| | | | modified polyolefin |
| | 1-15 | Polyolefin Blend | LDPE, HDPE, LLDPE, PP, COC, or |
| | | 90-25% LDPE | blends |
| | | 10-75% CaCO3 | |
| I. | 8-20 | Polyolefin | LDPE, HDPE, LLDPE, PP, COC, or |
| | | | blends |
| | 80-300 | Paperboard | |
| | 1-15 | Functional Barrier | Polyamide |
| | 1-15 | Functional Barrier | EVOH, PET, or blends |
| | 1-10 | Tie Layer | EAA, EMAA, EVA, Ionomer, Anhydride- |
| | | | modified polyolefin |
| | 5-30 | Polyolefin Blend | LDPE, HDPE, LLDPE, PP, COC, or |
| | | 90-25% LDPE | blends |
| | | 10-75% CaCO3 | |
| | 1-10 | Tie Layer | EAA, EMAA, EVA, Ionomer, Anhydride- |
| | | | modified polyolefin |
| | 1-15 | Functional Barrier | Polyamide, EVOH, PET, or blends |
| | 1-10 | Tie Layer | EAA, EMAA, EVA, Ionomer, Anhydride- |
| | | | modified polyolefin |
| | 1-15 | Polyolefin Blend | LDPE, HDPE, LLDPE, PP, COC, or |
| | | 90-25% LDPE | blends |
| | | 10-75% CaCO3 | |

A masterbatch of 75 wt. % calcium carbonate in 25 wt. % LDPE was used as the filler. In all of the embodiments as hereinafter described, the masterbatch was dry blended with resin at the time of processing.

Blends of 0, 20, 40 and 60 weight % calcium carbonate masterbatch (final loading levels of 0, 15, 30 and 45 weight %) in 1924 P LDPE were extruded onto a commercial barrier gable structure which had not been provided with a food contact layer. The structure comprised an exterior coating of Eastman 1924P bleached paperboard substrate, Honeywell B73QP polyamide (functional oxygen and scalping barrier) and a Plexar 5125 tie layer.

The resulting structure was

| | Target Coating |
|---|---|
| | Weight |
| Layer Description | (lbs/3000 ft²) |
| Exterior Coating | 12 |
| Paperboard Substrate | 257 |
| Functional Barrier | 5 |
| Tie Layer | 14 |
| Food Contact Layer | 12 |

The LDPE layer was extrusion coated onto the paperboard. The polyamide and tie layer were then deposited as a coextrusion coating to the paperboard and the polyolefin containing filler, then applied over the tie layer. While this is one method of forming the structures, other methods can be employed to result in the same final structure. Other structures were prepared using conventional coating and extrusion techniques. The completed laminates can be heat sealed from front to back (polyolefin to filled polyolefin) or back to back (filled polyolefin to filled polyolefin) at conventional temperatures.

All of the structures were converted into half-gallon gable top cartons, filled with orange juice purchased at retail outlet, refrigerated, and tested for orange peel oil content over a 28 day shelf life. Flavor and aroma compound concentrations are known to correlate well with changes in peel oil concentrations. The phenomenon of scalping occurs rapidly (i.e., within approximately 2 weeks) reaching a quasi-state of equilibrium whereupon further losses in flavor and aroma concentrations decrease at slower rate controlled by the permeation of oxygen into package.

The peel oil concentrations determined on cartons in duplicate for each filler loading percent and storage time clearly demonstrate the reduction in absorption of peel oil as loading increased.

### Orange Peel Oil Concentration (%)

| | |
|---|---|
| | Refrigerated Storage |
| % CaCO₃ | Time (days) |

| Loading | 2 | 15 | 29 |
|---|---|---|---|
| 0% | | | |
| Mean | 0.0185 | 0.0150 | 0.0148 |
| Std. Dev. | 0.0011 | 0.0000 | 0.0014 |
| 15% | | | |
| Mean | 0.0179 | 0.0170 | 0.0152 |
| Std. Dev. | 0.0014 | 0.0017 | 0.0008 |
| 30% | | | |
| Mean | 0.0203 | 0.0146 | 0.0185 |
| Std. Dev. | 0.0008 | 0.0011 | 0.0000 |
| 45% | | | |
| Mean | 0.0197 | 0.0191 | 0.0167 |
| Std. Dev. | 0.0005 | 0.0003 | 0.0014 |

It is evident from a graph of the data along linear lines of best fit that the zero time intercepts are not equivalent, but rather decrease with decreasing levels of filler added. Since the same orange juice was used for all cartons (i.e., equal oil concentrations), the initial absorption rate of peel oil is, therefore, greatest for lowest addition levels suggesting that the filler acts as a barrier to oil permeation as well as providing exclusion areas within which the oil is not soluble.

[image]

The basis weight of polyethylene as reduced by increased weight/weight % of filler addition was also calculated. By dividing the peel oil content of the juice by the calculated polyethylene basis weight in the food contact layer, a relative measure of the solubility of peel oil in polyethylene should result. Neglecting any interaction between the calcium carbonate and polyethylene, one would expect to obtain a constant value independent of loading level. Because the tie and functional barrier layers were extrusion coated independently of the extrusion coating of the filler loaded polyethylene and all variables were manufactured at same time without adjustments to nylon/tie resin co-extrusion, the amount of available polyethylene underneath the food contact layer was constant. Calculations including the tie layer, therefore, involve a constant that only changes absolute value but not relative position of filler addition levels. The following graph illustrates that there was interaction between the calcium carbonate and polyethylene producing a beneficial effect that exceeded the expected volume exclusion for calcium carbonate particles.

[image]

The invention can be used in producing structures of coated paperboard for use in the production of containers and cartons for products such as juices, punches, milk and other beverages, which structures are made from a laminate having a paperboard substrate, one or more nylon, EVOH, or PET layers overlying the interior surface of the substrate, and one or more polyolefin layers adhered to the one or more nylon, EVOH, or PET layers via an adhesive tie layer, sublayer(s), and a food contact layer having incorporated therein an inorganic filler. A layer of polyolefin is preferably coated on the exterior surface of the paperboard substrate. The structures can utilize aluminum foil as the barrier layer in which case a tie or polyolefin layer is interposed between the foil and the paperboard substrate.

The layers can be achieved by either coextrusion or by standard lamination or extrusion lamination processes.

1. A laminate comprising:
a. a paperboard substrate having opposed inner and outer surfaces,
b. a layer of heat sealable olefin polymer coated onto the outer surface of the paperboard substrate,
c. a layer of a functional barrier material coated onto the inner surface of the paperboard substrate,
d. a heat sealable layer of olefin polymer containing inorganic particulate filler coated onto the outer surface of the functional barrier layer wherein the heat sealable layer of polyolefin polymer containing filler constitutes the food contact layer.

2. A laminate according to claim 1 wherein the olefin polymer comprising the polymer layer coated on the outer surface of the paperboard substrate is low density polyethylene.

3. A laminate according to claim 1 wherein the functional barrier material is a member selected from the group consisting of polyamide, EVOH, PET, blends thereof and aluminum foil.

4. A laminate according to claim 1 wherein the functional barrier material is polyamide.

5. A laminate according to claim 1 wherein the functional barrier material is EVOH.

6. A laminate according to claim 1 wherein the functional barrier material is PET.

7. A laminate according to claim 1 wherein the functional barrier material is aluminum foil.

8. A laminate according to claim 1 wherein a tie layer is applied onto the outer surface of the functional barrier layer intermediate the functional barrier layer and the food contact layer.

9. A laminate according to claim 1 wherein a tie layer containing inorganic particulate filler is applied onto the outer surface of the functional barrier layer intermediate the functional barrier layer and the food contact layer.

10. A laminate according to claim 8 wherein the tie layer comprises a member selected from the group consisting of anhydride modified polyolefin, ethylene acrylic acid, ethylene methyl acrylic acid, ethylene vinyl acetate and ionomer.

11. A laminate according to claim 1 wherein said inorganic particulate filler is a member selected from the group consisting of metal carbonates, metal hydroxides, metal oxides, metal sulfates, clay, kaolin, talc, silica diatomaceous earth, alumina, mica, glass powder and zeolites.

12. A laminate according to claim 1 wherein said inorganic particulate filler is calcium carbonate.

13. A laminate according to claim 1 wherein said inorganic particulate filler is present with a loading of 10-75 weight percent.

14. A laminate according to claim 1 wherein at least one additional layer is present between the inner surface of the paperboard and the functional barrier layer, the additional layer being a member selected from the group consisting of LDPE, HDPE, LLDPE, polypropylene, cyclic olefin copolymer resins containing calcium carbonate, and a tie material.

15. A laminate according to claim 9 wherein the at least one layer of polymeric material is applied onto the outer surface of the tie layer.

16. A laminate according to claim 15 wherein the at least one layer of polymer material applied onto the outer surface of the tie layer is a second barrier layer.

17. A laminate according to claim 16 wherein the second barrier layer is an EVOH copolymer containing 26-44 mol % ethylene.

18. A laminate according to claim 9 wherein at least one layer of polymeric material containing inorganic particulate filler is applied onto the outer surface of the tie layer.

19. A laminate according to claim 1 wherein the barrier layer contains inorganic particulate filler.

20. A laminate according to claim 16 wherein the second barrier layer contains inorganic particulate filler.

21. A laminate according to claim 1 wherein a heat sealable layer of polyolefin is applied onto the polyolefin layer containing inorganic particulate filler.

22. A laminate according to claim 16 wherein a second tie layer is applied intermediate the second layer of barrier material and the layer of polyolefin containing inorganic particulate filler comprising the food contact layer.

23. A inorganic filler material according to claim 1 wherein the polyolefin containing inorganic particulate filler comprises 90-25% LDPE and 10-75% CaCO₃.

24. A laminate comprising:
a. a paperboard substrate having opposed inner and outer surfaces,
b. a layer of heat sealable olefin polymer coated onto the outer surface of the paperboard substrate,
c. a layer of a functional barrier material coated onto the inner surface of the paperboard substrate,
d. a tie layer containing inorganic particulate filler applied onto the outer surface of the functional barrier layer,
e. at least one layer of a polymer material containing inorganic particulate filler applied onto the outer surface of the tie layer, and
f. a heat sealable layer of olefin polymer containing inorganic particulate filler coated onto the outer surface of the last of the layers of polymer material applied onto the tie layer.

25. A laminate comprising:
a. a paperboard substrate having opposed inner and outer surfaces,
b. a layer of heat sealable olefin polymer coated onto the outer surface of the paperboard substrate,
c. a layer of a functional barrier material coated onto the inner surface of the paperboard substrate,
d. a tie layer containing inorganic particulate filler applied onto the outer surface of the functional barrier layer,
e. at least one layer of a polymer material containing inorganic particulate filler applied onto the outer surface of the tie layer, and
f. a heat sealable layer of olefin polymer coated onto the outer surface of the last of the layers of polymeric material applied onto the tie layer wherein the heat sealable layer of olefin polymer comprises the food contact layer.

26. A laminate according to claim 25 wherein an additional layer of a functional barrier material is coated onto said layer of functional barrier layer c. and wherein said at least one layer applied onto the outer surface of said tie layer d. is a barrier layer.

27. A blank for use in producing a container or carton for beverages constructed from a laminate according to claim 1.

28. A container for beverages constructed from a laminate structure according to claim 1.
